(19) United States
(12) Patent Application Publication
(10) Pub. No.: US 2013/0233108 A1
(43) Pub. Date: Sep. 12, 2013

(54) Combination Double Thread Screw

(71) Applicant: Yuan-Chuen Chen, Changhua Hsien (TW)

(72) Inventor: Yuan-Chuen Chen, Changhua Hsien (TW)

(21) Appl. No.: 13/413,746

(22) Filed: Mar. 7, 2012

(51) Int. Cl. F16H 55/12

(52) U.S. Cl. 74/439

(57) ABSTRACT

A double thread screw includes a mandrel, a plurality of threaded blocks mounted on the mandrel, and two ends stops mounted on the mandrel. The mandrel has a periphery provided with a plurality of locking faces. The threaded blocks are clamped between and limited by the ends stops. Each of the threaded blocks has a central portion provided with a locking hole locked onto the locking faces of the mandrel. Each of the threaded blocks has a periphery provided with two first thread grooves which intersect each other and have two opposite threading directions. The first thread grooves of the threaded blocks are combined to form two intersecting threads which are arranged successively in a staggered manner and are directed in two opposite threading directions.

### BACKGROUND OF THE INVENTION

1. Field of the Invention

The present invention relates to a double thread screw and, more particularly, to a combination double thread screw for a precision transmission apparatus or a motorized mechanism.

2. Description of the Related Art

A conventional double thread screw comprises an elongate rod and two intersecting threads (rightward helical thread and leftward helical thread) formed on the elongate rod. The two threads are arranged successively in a staggered manner and are directed in two opposite threading directions. In operation, a nut is screwed onto the double thread screw. Thus, when the double thread screw is driven and rotated, the nut is moved on the double thread screw reciprocally by provision of the two threads. The double thread screw is available for a precision transmission apparatus or a motorized mechanism. The two intersecting threads are formed on the elongate rod by turning. However, the working process of the two intersecting threads is complicated and difficult, thereby increasing the cost of fabrication. In addition, the double thread screw has determined specifications and sizes so that the double thread screw cannot fit a requirement of different specifications and sizes, thereby limiting the versatility of the double thread screw. Further, when a user needs to have a double thread screw of different specification and size, he has to order and design the double thread screw additionally and previously and has to wait the product for a long period of time, thereby wasting the time and increasing the cost of fabrication.

### BRIEF SUMMARY OF THE INVENTION

In accordance with the present invention, there is provided a double thread screw, comprising a mandrel, a plurality of threaded blocks mounted on the mandrel, and two ends stops mounted on the mandrel to limit the threaded blocks. The mandrel is a polygonal elongate bar and has a periphery provided with a plurality of locking faces which are connected with each other. The threaded blocks are clamped between and limited by the ends stops. Each of the threaded blocks has a central portion provided with a locking hole locked onto the locking faces of the mandrel. The locking hole of each of the threaded blocks has a polygonal shape. Each of the threaded blocks has a periphery provided with two first thread grooves which intersect each other. The first thread grooves of each of the threaded blocks have two opposite threading directions. The first thread grooves of the threaded blocks are combined to form two intersecting threads which are arranged successively in a staggered manner and are directed in two opposite threading directions.

Each of the threaded blocks has two beveled faces formed on two opposite ends thereof. Each of the threaded blocks has a first side provided with a wide portion located between the beveled faces and a second side provided with a narrow portion located between the beveled faces. The wide portion of each of the threaded blocks has a width greater than that of the narrow portion. The wide portion of one of the threaded blocks is juxtaposed to the narrow portion of another one of the threaded blocks so that the wide portions and the narrow portions of the threaded blocks are arranged successively in a staggered manner. The beveled faces of the threaded blocks engage each other, and the first thread grooves of the threaded blocks are connected with each other.

Each of the ends stops is a bushing. Each of the ends stops has a central portion provided with a locking bore locked onto the locking faces of the mandrel. The locking bore of each of the ends stops has a polygonal shape. Each of the ends stops has an end portion provided with a beveled surface. Each of the ends stops has a periphery provided with two second thread grooves which intersect each other. The second thread grooves of each of the ends stops have two opposite threading directions. The beveled surface of each of the ends stops engages one of the beveled faces of a respective one of the threaded blocks, and the second thread grooves of each of the ends stops are connected to the first thread grooves of a respective one of the threaded blocks.

The primary objective of the present invention is to provide a double thread screw whose length can be changed.

According to the primary advantage of the present invention, the number of the threaded blocks can be changed to construct the double thread screw with different length, so that the size of the double thread screw can be adjusted freely by changing the number of the threaded blocks so as to fit the requirements of different users, thereby enhancing the versatility of the double thread screw, and thereby decreasing the cost of fabrication.

According to another advantage of the present invention, the size of the double thread screw can be adjusted by changing the number of the threaded blocks so that the manufacturer needs not to prepare and store double thread screws of different sizes and specifications, thereby greatly decreasing the cost of storage.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a double thread screw in accordance with the preferred embodiment of the present invention.

FIG. 2 is an exploded perspective view of the double thread screw as shown in FIG. 1.

FIG. 3 is a front view of the double thread screw as shown in FIG. 1.

FIG. 4 is a front cross-sectional view of the double thread screw as shown in FIG. 3.

FIG. 5 is a top view of the double thread screw as shown in FIG. 1.

### DETAILED DESCRIPTION OF THE INVENTION

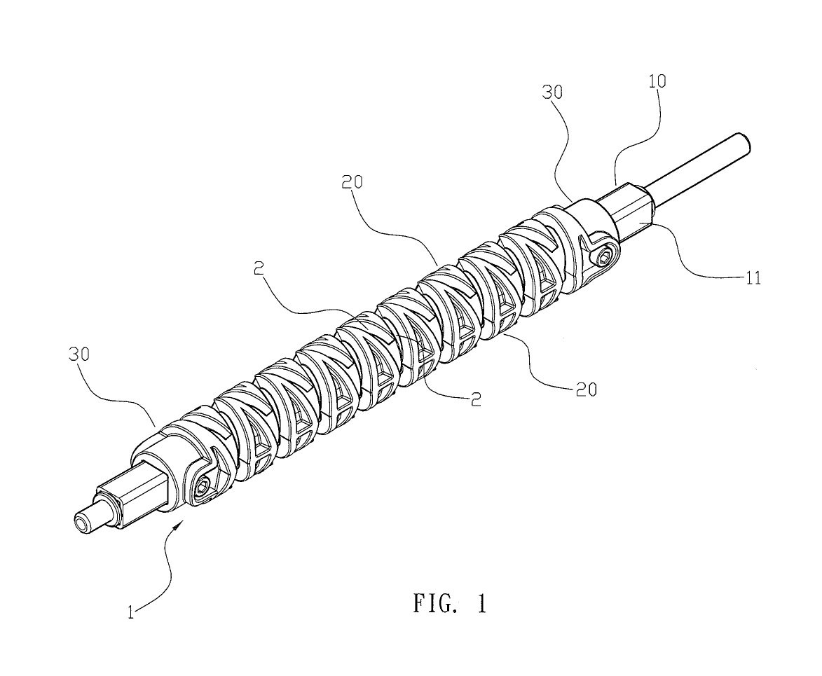

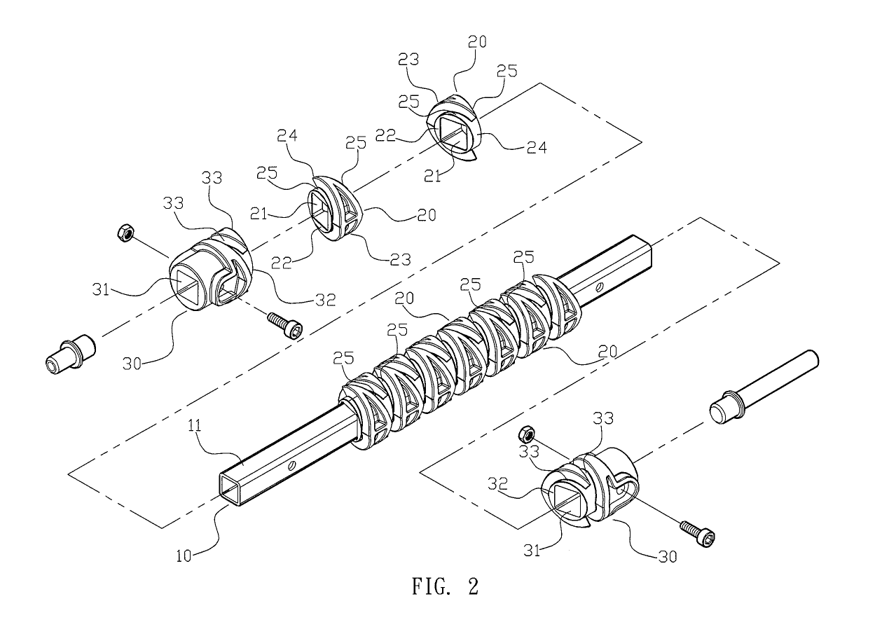

Referring to the drawings and initially to FIGS. 1 and 2, a double thread screw 1 in accordance with the preferred embodiment of the present invention comprises a mandrel 10, a plurality of threaded blocks 20 mounted on the mandrel 10, and two ends stops 30 mounted on the mandrel 10 to limit the threaded blocks 20.

The mandrel 10 is a polygonal elongate bar and has a periphery provided with a plurality of locking faces 11 which are connected with each other.

The threaded blocks 20 are clamped between and limited by the ends stops 30. Each of the threaded blocks 20 has a central portion provided with a locking hole 21 locked onto the locking faces 11 of the mandrel 10 so that each of the threaded blocks 20 is combined with the mandrel 10 to rotate in concert with the mandrel 10. The locking hole 21 of each of the threaded blocks 20 has a polygonal shape. Each of the threaded blocks 20 has a periphery provided with two first thread grooves 25 which intersect each other. The first thread grooves 25 of each of the threaded blocks 20 have two opposite threading directions. Each of the threaded blocks 20 has two beveled faces 22 formed on two opposite ends thereof. Each of the threaded blocks 20 has a first side provided with a wide portion 23 located between the beveled faces 22 and a second side provided with a narrow portion 24 located between the beveled faces 22. The wide portion 23 of each of the threaded blocks 20 has a width greater than that of the narrow portion 24.

Each of the ends stops 30 is a bushing. Each of the ends stops 30 has a central portion provided with a locking bore 31 locked onto the locking faces 11 of the mandrel 10. The locking bore 31 of each of the ends stops 30 has a polygonal shape. Each of the ends stops 30 has an end portion provided with a beveled surface 32. Each of the ends stops 30 has a periphery provided with two second thread grooves 33 which intersect each other. The second thread grooves 33 of each of the ends stops 30 have two opposite threading directions.

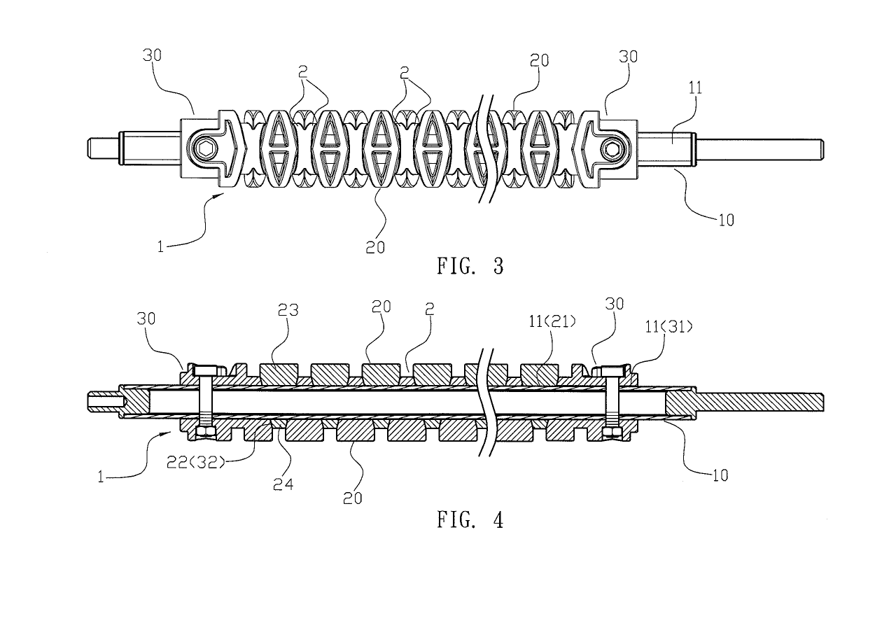

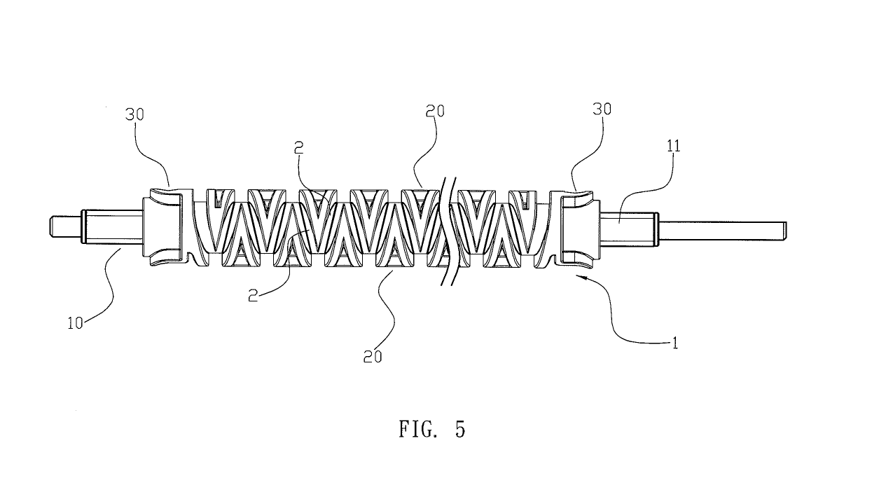

In assembly of the double thread screw 1, referring to FIGS. 3-5 with reference to FIGS. 1 and 2, the threaded blocks 20 are mounted on the mandrel 10 serially with the locking hole 21 of each of the threaded blocks 20 being locked onto the locking faces 11 of the mandrel 10. At this time, the wide portion 23 of one of the threaded blocks 20 is juxtaposed to the narrow portion 24 of another one of the threaded blocks 20 so that the wide portions 23 and the narrow portions 24 of the threaded blocks 20 are arranged successively in a staggered manner. In addition, the beveled faces 22 of the threaded blocks 20 engage each other, and the first thread grooves 25 of the threaded blocks 20 are interconnected with each other. Then, each of the ends stops 30 is mounted on the mandrel 10 with the locking bore 31 of each of the ends stops 30 being locked onto the locking faces 11 of the mandrel 10. At this time, the beveled surface 32 of each of the ends stops 30 engages one of the beveled faces 22 of a respective one of the threaded blocks 20, and the second thread grooves 33 of each of the ends stops 30 are connected to the first thread grooves 25 of a respective one of the threaded blocks 20. Thus, the mandrel 10, the threaded blocks 20 and the ends stops 30 are combined together to construct the double thread screw 1, and the first thread grooves 25 of the threaded blocks 20 and the second thread grooves 33 of the ends stops 30 are interconnected and combined to form two intersecting threads 2 which are arranged successively in a staggered manner and are directed in two opposite threading directions. At this time, the threaded blocks 20 are clamped between and limited by the ends stops 30 so that the threaded blocks 20 will not be detached from the mandrel 10.

Accordingly, the number of the threaded blocks 20 can be changed to construct the double thread screw 1 with different length, so that the size of the double thread screw 1 can be adjusted freely by changing the number of the threaded blocks 20 so as to fit the requirements of different users, thereby enhancing the versatility of the double thread screw 1, and thereby decreasing the cost of fabrication. In addition, the size of the double thread screw 1 can be adjusted by changing the number of the threaded blocks 20 so that the manufacturer needs not to prepare and store double thread screws 1 of different sizes and specifications, thereby greatly decreasing the cost of storage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A double thread screw, comprising:
a mandrel;
a plurality of threaded blocks mounted on the mandrel; and
two ends stops mounted on the mandrel to limit the threaded blocks;
wherein the mandrel is a polygonal elongate bar and has a periphery provided with a plurality of locking faces which are connected with each other;
the threaded blocks are clamped between and limited by the ends stops;
each of the threaded blocks has a central portion provided with a locking hole locked onto the locking faces of the mandrel;
the locking hole of each of the threaded blocks has a polygonal shape;
each of the threaded blocks has a periphery provided with two first thread grooves which intersect each other;
the first thread grooves of each of the threaded blocks have two opposite threading directions;
the first thread grooves of the threaded blocks are combined to form two intersecting threads which are arranged successively in a staggered manner and are directed in two opposite threading directions.

2. The double thread screw of claim 1, wherein
each of the threaded blocks has two beveled faces formed on two opposite ends thereof;
each of the threaded blocks has a first side provided with a wide portion located between the beveled faces and a second side provided with a narrow portion located between the beveled faces;
the wide portion of each of the threaded blocks has a width greater than that of the narrow portion;
the wide portion of one of the threaded blocks is juxtaposed to the narrow portion of another one of the threaded blocks so that the wide portions and the narrow portions of the threaded blocks are arranged successively in a staggered manner;
the beveled faces of the threaded blocks engage each other; and
the first thread grooves of the threaded blocks are connected with each other.

3. The double thread screw of claim 1, wherein
each of the ends stops is a bushing;
each of the ends stops has a central portion provided with a locking bore locked onto the locking faces of the mandrel;
the locking bore of each of the ends stops has a polygonal shape;
each of the ends stops has an end portion provided with a beveled surface;
each of the ends stops has a periphery provided with two second thread grooves which intersect each other;
the second thread grooves of each of the ends stops have two opposite threading directions;
the beveled surface of each of the ends stops engages one of the beveled faces of a respective one of the threaded blocks; and
the second thread grooves of each of the ends stops are connected to the first thread grooves of a respective one of the threaded blocks.
